(19) United States
(12) Patent Application Publication
(10) Pub. No.: US 2001/0042138 A1
(43) Pub. Date: Nov. 15, 2001

(54) Method and system for parallel and procedural computing

(76) Inventor: Reinhard Buendgen, Tuebingen (DE)

Correspondence Address: Ronald L Drumheller, Esq., 94 Teakettle Spout Road, Mahopac, NY, 10541, US

(21) Appl. No.: 09/748,450

(22) Filed: Dec. 26, 2000

(30) Foreign Application Priority Data
Dec. 23, 1999 (EP) 99125775.9

(51) Int. Cl. G06F 9/00; G06F 9/54; G06F 15/163

(52) U.S. Cl. 709/310

(57) ABSTRACT

The present invention relates to parallel computing. It allows to compute parts of a sequential program as e.g., functions or subprograms or procedures in parallel on a multi-processor computer, a cluster or a network of cumputers (10, 12, 14, 16) based on the message passing paradigm. In this concept of ‘Procedural Parallel operating environment’ all infrastructure needed to allow for parallel computation is encapsulated in a parallel procedure call (18).

### 1. BACKGROUND OF THE INVENTION

1.1 Field of the Invention

The present invention relates to the field of parallel computing. In particular, it relates to a method and system for running in parallel code portions of a program, especially sub-programs, functions, etc.

1.2 Description and Disadvantages of Prior Art

In the field of prior art parallel computing a program can be called and run multiply in order to increase the program's execution speed. In particular, when the same program shall be executed on different computers without any shared memory between the multiple instances of said program prior art message passing methods and mechanisms are used for exchanging information between the instances of said program. In addition prior art message passing methods are used to transfer standard (i.e. terminal) input and output of the instances of said program to a single point of control. A prior art tool which is able to manage a task like that is the IBM Parallel Operating Environment, further referred to herein as POE.

Said prior art POE tool is able to manage parallel execution of programs as a whole. Nearly all programs consist of a plurality of sub-units, for example sub-programs, or functions which encapsulate some computational work and which can be called by a calling statement located somewhere in the main program. Very often, the principle of calling a specialized program sub-unit is repeated in deeper levels of the program as for example in a subprogram or in a function, again. Thus, calls are staggered.

The most important issues of any parallel computing management is to synchronize and organize the data serving as input or output for the parallel executing program such that program data will be properly worked on. Such a management is even more complex when the same program is run distributed on multiple locations in a wide area network (WAN). Then, as well when a local area network (LAN) is used prior art message passing is used for sending and receiving such data properly in order to be able to achieve the correct result of the program run.

Said prior art parallel computing is limited, however, on a program level whereas it is often desired to parallelize only fractions of the total program code, i.e., to achieve a finely grained level of parallelization For example, it is desired to run only a sub-program in parallel which consumes a large execution time when it is run on a single machine. Or, in one program there are a plurality of such sub-programs having each such a long execution time. Or, there are sub-programs having a different single-processor execution time such that it is desired to execute—e.g. a sub-program A distributed on three machines, sub-program B on five machines, and sub-program C only on two machines, i.e computing devices distributed in the network in order to achieve a good compromise between overall program execution time and reliability of parallel program execution.

Thus, the prior art approach is not flexible enough to satisfy the above mentioned requirements.

Additionally, any parallelized computing is generally more prone to error compared to sequential computing because components of a parallel computing environment (both the computing devices involved and the connections between the computing devices) must be working for a parallel program to work. Thus, a way of computing is desired which restricts the risks of parallel computing to the parts of the program where parallel computation is really needed by selecting particular parts of a program to be computed in parallel whereas computing the rest of the program in non-parallel way Prior art parallel computing forces to run a whole program in parallel eventhough only part of it really expoits parallelism.

1.3 Objects of the Invention

Thus, it is an object of the present invention to increase the flexibility in parallel computing.

### 2. SUMMARY AND ADVANTAGES OF THE INVENTION

These objects of the invention are achieved by the features stated in enclosed independent claims. Further advantageous arrangements and embodiments of the invention are set forth in the respective subclaims.

The basic inventional concepts, referred to and abbreviated herein as ‘Procedural POE’ can be realized as an extension of an already existing parallel program management tool like it is for example the IBM Parallel operating Environment (POE).

The parallel functions of procedural POE use the Message Passing Interface further referred to and abbreviated herein as MPI as message passing application program interface (API). The parallel functions of Procedural POE are managed as parallel processes using the prior art parallelization infrastructure of POE.

Summarizing shortly the basic principles of the proposed solution an application programmer who wants to exploit the inventional matter for a particular application program—original program—and wants to compute a particular method (function or procedure) in parallel the programmer creates a call to Procedural POE in said original program. This call uses a standard name. Arguments of said standard function are:

the name of the function to be computed in parallel, serialized arguments of said latter function, a variable for receiving the result, and various parallelization parameters which control the parallelization work. Said call creates a new process (spawn) namely a poe process which in turn calls an envelope program—called parallel subprogram—that calls the function or procedure to be actually computed in parallel. The arguments required for the parallel subprogram are passed through by the created poe process to the parallel subprogram as command line arguments.

According to the basic principles of the present invention Procedural POE comprises three essential components:

1. A template for a main program calling a parallel function or procedure. The instantiated template can be called as a parallel program by POE.

2. A tool for automatically instantiating said template.

3. A set of library functions that support the call of parallel functions or procedures. These functions take as arguments the name of a parallel function or procedure, its arguments in a serialized form and parallelization parameters. Their key task is to spawn a process which is managed by a parallel process manager like POE, i.e., for example a POE process that starts a parallel program. This parallel program has been derived from a template that was instantiated with the parallel function or procedure to be called.

According to an advantageous aspect the inventional method further comprises the step of generating said parallel method with a script program means which in turn is arranged to invoke a stream editor means in order to fill a template means with the code of the method to be computed in parallel. With that feature parallel computing can be automated and hidden from the user.

In order to achieve that the following issues have to be considered to be solved and respective design proposals are made as follows.

1. How to pass arguments from the original program to the parallel methods,

2. How to pass results from a parallel function back to the original program,

3. Calling parallel methods synchronously or asynchronously,

4. Which programming languages are to be supported,

5. Is the function-level analogue of the ‘multiple programs multiple data’ approach further referred herein as MPMD supported?

Advantageous and exemplary solutions to the above-mentioned issues are as follows:

1. Arguments are passed as command line arguments to the parallel subprogram.

2. Results are passed via standard output from the parallel subprogram to POE and via interprocess communication as are e.g., pipes, named pipes, shared memory segments from POE to the original program.

3. Special APIs for both synchronous and asynchronous calls to parallel methods can be provided.

4. Any language can be supported. Further below, it is described exemplarily how the C-APIs for Procedural POE will look like.

5. The function-level analogue of MPMD requires a more involved API than the single program multiple data further refereed to herein as SPMD analogue. In here, it is described how the API for the SPMD analogue would look like.

In order to keep both the user interface and the realization of Procedural POE as simple as possible some conventions and restrictions can be advantageously applied. This is described in more detail along with the preferred embodiment of the inventional method further below.

The following advantages can thus be achieved: Time consuming parts of existing programs can be parallelized without changing the setup or infrastructure of the existing program: The time consuming part may be replaced by a subprogram means invoking the parallel method like a function or procedure, etc. This modification does not require that the calling program “is aware” that it calls a parallel code as no changes are required in the caller program source code.

The inventional concepts can be comprised of a program library. Further, such library supports to generate user libraries that contain parallelized functions. Programs calling these functions need not be enabled to run parallel code. I.e., parallelism in these parallelized functions is transparent to the calling program and therefore results in reduced maintenance.

Further, it can be achieved an improved compromise between program execution speed and reliability of parallel program execution.

Several parallel functions may independently and concurrently run in a program without any interference.

The systems and nodes on which the parallel subprograms run need not have a particular server process like a daemon in a UNIX environment waiting to run the parallel functions or procedures.

### 3. BRIEF DESCRIPTION OF THE DRAWINGS

The present invention is illustrated by way of example and is not limited by the shape of the figures of the accompanying drawings in which:

FIG. 1 is a schematic illustration of the raw structure of the inventional concept of parallelizing subprograms,

FIG. 2 is a schematic block diagram showing the essential steps in control flow and information describing the essentials of the inventional method of running subprograms in parallel, and

FIG. 3 is a schematic block diagram showing additional details of the inventional method.

### 4. DESCRIPTION OF THE PREFERRED EMBODIMENT

Before entering into the detailed descriptions of the drawings the following notions are considered to be helpful in describing the concepts of Procedural POE:

original program, caller program:

This is a progam that conceptionally calls a parallel function or procedure

Procedural POE call:

A call to poe_call_func_sync or poe_call_func_async

Parallel method:

A procedure or function of type poe_call_func_type that is to be called in parallel.

Two kinds of parallel methods may be distinguished:

parallel procedures (result_size<=0) and

parallel functions (result_size>0)

This corresponds to the prior art basics.

Parallel subprogram source:

An instantiation of the template poe_call_main_xxx.c with a parallel method.

For example, if the parallel method is denoted as “parprocT” the instantiation is denoted as poe_call_main_parproc.c

Parallel subprogram:

Executable derived from the parallel subprogram source. It actually calls the parallel method.

In order to keep both the user interface and the realization of Procedural POE as simple as possible some conventions and restrictions can be advantageously applied. They are as follows:

Parallel Methods:

Parallel methods are of the C-type poe_call_func_type:

typedef char* (*poe_call_func_type)(char** arguments)

Parallel methods may not use standard I/O explicitly. The restrictions to use standard output for parallel procedures and the standard error stream may be relieved later.

Argument lists are passed as arrays of strings with the first NULL-string denoting the end of the argument list.

This means all arguments of a parallel method must be serialized to strings or—if necessary arrays of strings by the application programmer. The size of the arguments may he restricted by system restrictions to the size of command line arguments.

Arguments and the result are represented as strings. Therefore the parallel method must serialize its result to a string before it returns a result. The memory for the result must be allocated dynamically within the parallel method. Parallel methods that return a result may not use standard output because standard output will be (mis)used to pass the result from the parallel subprogram to the POE process. The size of the result is restricted by the result_size parameter of the Procedural POE call.

It is the responsibility of the application programmer to ensure that all parallel instances of the parallel method contribute to the result in a way that it can be interpreted unambiguously by the orginal program. E.g., the overall result is collected and returned by a single process and all other processes return NULL. Of course, other implementations can be applied as well.

Parallel Subprograms:

The parallel subprogram associated with a parallel method 28 will be built from a template poe_call_main_xxx.c by the shell script poe call build that takes the name of the parallel method as first argument. The resulting parallel subprogram source will be compiled and linked using a parallel compiler which is in combination with POE ‘mpcc’. Said shell script may pass arguments following the parallel method name to the parallel compiler.

Said parallel method 28 can advantageously be generated with said script program means as a shell script in UNIX, or job control cards in MVS, or batch files in other environments. The script means is arranged to invoke a stream editor in order to fill a template means with the name/code of the method 28 to be computed.

The resulting executable for the parallel subprogram is proposed to have the name poe_call_main_<name of parallel method>. This naming scheme must be fix and the functions poe_call_func_sync( ) and poe_call_func_async( ) assume that a program with such a name is executable via the current environment path.

Before calling the parallel method the parallel subprogram calls MPI_Init and it calls MPI_Finalize before exiting. It uses a new function poe_return_result which can be implemented as follows:

void poe return result(char* result);

for passing the result to POE. It is suggested that

poe_return_result will write the result to standard output.

poe_return_result will be opaque to the user.

Modifications needed in the prior art POE command:

When starting a parallel subprogram POE must detect whether a result must be received from the parallel subprogram and passed back to the original program. If a result is to be passed back the standard output—from the parallel subprogram must be redirected to be sent to the original program.

To inform POE about its duty to pass on a result a new POE command line option “-poeresult” is introduced. The value passed with -poeresult denotes the interprocess communication means to be used. This command line option needs not be made public.

Next, an API for the C programming language is presented. The following functions and definitions will be introduced by Procedural POE:

synchronous parallel method call:

synchronous parallel method call:
error_t_poe_call_func_sync ( char* par_func_name,

char** arguments,
char** result,
int result_size,
int times,
char** poe_options)

Parameters:

1. par_func_name: name of a parallel method of type poe_call_func_type to be called in parallel

2. arguments: serialized arguments (array of strings) to be passed to the parallel method

3. result: reference to string containing (serialized) result of parallel method (NULL if result_size <=0)

4. result_size: upper bound of the expected result size, a value less or equal to 0 means that no result is expected

5. times: number of copies of the parallel method to be started (positive integer)

6. poe_options: list of POE options (array of strings) to be passed to POE call used to start parallel method

Return value: error indicator

asynchronous parallel method call:

poe_pid_t_poe_call_func_async( char* par_func_name,

char** arguments,
int result_size,
int times,
char** poe_options)

Parameters:

1. par_func_name: name of a parallel method of type poe_call_func_type to be called in parallel

2. arguments: serialized arguments for example an array of strings, to be passed to the parallel method

3. result_size: upper bound of the expected result size, a value less or equal to 0 means that no result is expected

4. times: number of copies of the parallel method to be started (positive integer)

5. poe_options: list of POE options (array of strings) to be passed to POE call used to start parallel method

Return value:

Identifier needed to “join” asynchronous parallel method

completion of asynchronous method call:

error_t poe_wait(poe_pid_type pid, char** result)

Parameters:

1. pid: identifier needed to “join” parallel asynchronous method

2. result: reference to string containing (serialized) result of parallel method (NULL if result_size <=0)

Return value: error indicator

The following new C-specific types will be introduced:

type of a parallel method

typedef char* (*poe_call_func_type)(char** arguments)

type representing an asynchronous parallel method

typedef struct{pid_t pid; int result_size; . . . }

*poe_pid_t

The members of the poe_pid_type structure are not part of the general user programming interface. It is used for controlling and managing the flow back of the results computed by the parallel subprograms.

The declarations of these interfaces are advantageously provided by a new include file poe_call.h.

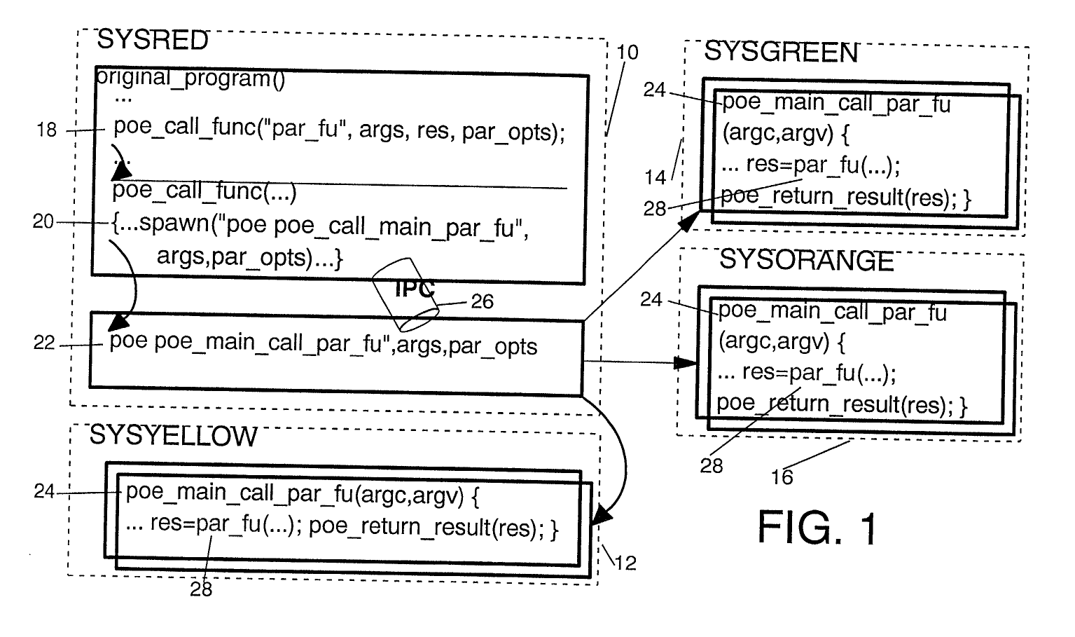

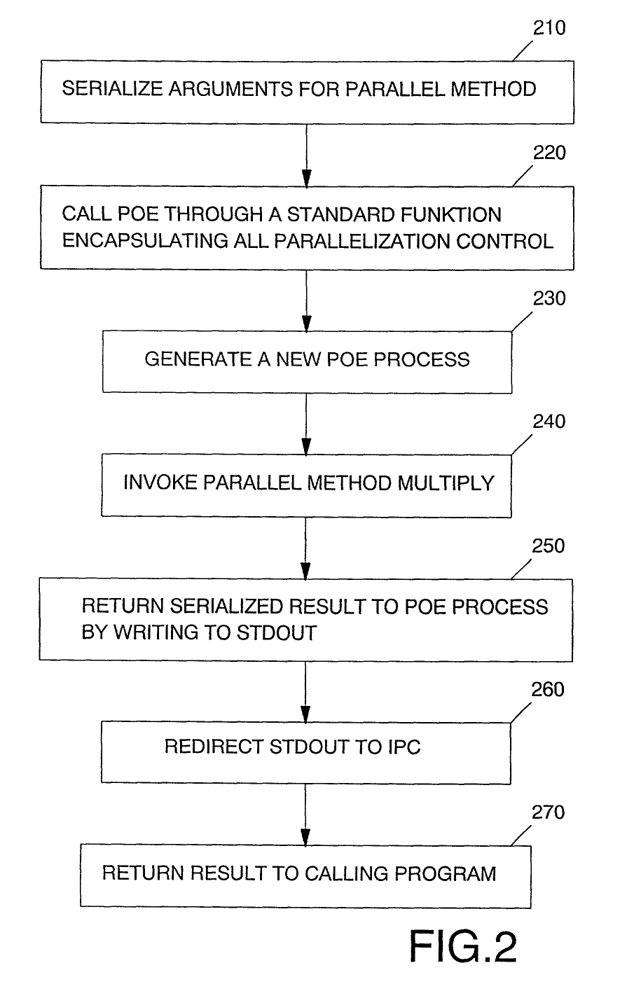

With general reference to the FIG. 1 and 2 the raw structure of the inventional concept exemplified in an embodiment of an extended IBM POE tool for parallelizing computing of subprograms is described next below together with the most essential steps in the control and information flow of the inventional procedural computing method.

An application program, referred to as ‘original program’ is started on a machine 10 i.e., any computer, workstation mainframe, cluster, etc. denoted as SYSRED. Further computers, SYSYELLOW 12, SYSGREEN 14, AND SYSORANGE 16 are connected to SYSRED via a network not explicitly depicted.

The original program shall invoke now a particular parallel method, referred to herein as par_fu three times in parallel. Thus, in a first step 210 the required arguments must be serialized in order to be ready to be transferred via the network as sequential data stream. Then step 220, the programmer creates a call 18 to procedural POE in said original program. This call 16 uses a standard name denoted in here as poe_call_func. Said call has basically one task to solve: Representing an envelope for hiding and encapsulating parallelization work to the programmer.

Arguments of said standard named function 16 are:

the name par_fu of the function to be computed in parallel, serialized arguments of said latter function, a variable for receiving the result, and various parallelization parameters which control the parallelization work which are described later herein in more detail. Given a parallel function par_fu, this is all the programmer whitnesses in terms of parallelization.

In a step 230 said call 18 creates a new process via a spawn (or fork/exec) command 20, namely a poe process 22 which in turn calls three times a main program 24 denoted as poe_main_call_par_fu hosted on said remote machines 12, 14, 16, step 240. Said main program is referred to herein as parallel subprogram. The name of the parallel subprogram must be automatically derivable from the name of the parallel method. E.g. poe_main_call_<name of parallel method>

Said main programs 24 in turn call the parallel method 28 par_fu in a step 240 to be actually computed in parallel. The arguments required for the parallel function are passed (as command line parameters) through to the parallel subprogram by the created poe process 22. The sources of the main programs 24 are generated according to a preferred aspect of the present invention from a template with a script which invokes a stream editor which in turn fetches the name and/or the code of the actual parallel function par_fu 28.

In addition to spawning the poe process 22, said call 18 sets up an interprocess communication (IPC) connection 26 between the original program and the then spwaned poe processs 22.

The results are fed back in a step 250 from the remote machines as standard output to the calling machine via said network connection and are then forwarded via interprocess communication means 26 by the inventional POE tool.

Therefore, POE redirects STDOUT to IPC, step 260.

Thus, the result data can properly be returned to the calling application program, step 270.

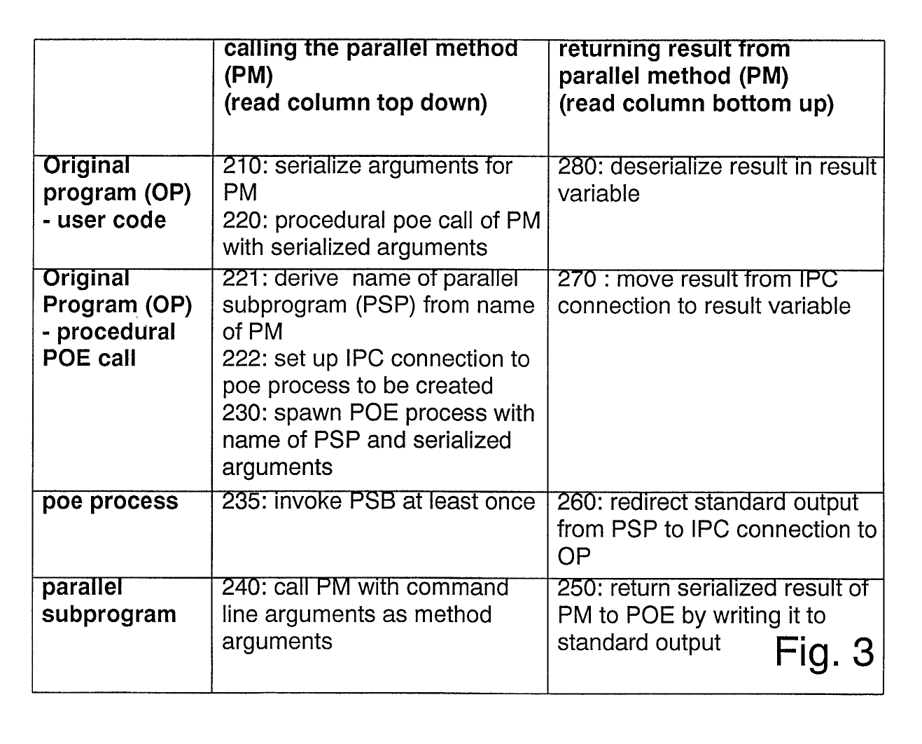

With reference now to FIG. 3 some more details in the above described method are given supplementally next below. Same reference signs refer to same steps. The left column of the drawing inducates the level or location on which the steps denoted in the middle and the right column are performed. The sequence of steps is from top to down in the middle column followed by the steps of the right column rom bottom to top. The numbers indicate the same. A cross-reference between FIG. 2 and 3 should now be made.

After step 220 the original program derives the name of the parallel subprogram PSP 24 from the name of the parallel method, see FIG. 1 ‘poe_main_call_par_fu’ derived from ‘parfu’—step 221.

Then, in a step 222 the IPC connection is setup to the POE process to be created.

Then, after step 230 in which the new POE process was created with the name of the parallel subprogram and with serialized arguments as POE arguments. Said POE process invokes the parallel subprogram at least once. In FIG. 1 this is depicted as three times for accessing three machines—step 235.

Then, after step 260 the original program moves the result from the IPC connection to the result variable, step 270, and the result can be deserialized by the original program, step 280.

With additional reference now to FIG. 1 and for completing the understanding next will be illustrated by way of commented C-code how procedural POE will be used by an application programmer when calling asynchronously a Parallel Method as a parallel function

in the Original Program

...
char *myresult;
int myresultsize
...
/* serialize arguments */
myargs=(char**)malloc(number_of_arguments_to_my_par_func*sizeof(c
har*));
myargs [0]=...
myargs [1]=...
/* serialize POE options */
mypoeopts=(char**)malloc(number_of_poe_options*sizeof(char*));
mypoeopts [0]=...
mypoeopts [1]=...
/* assess result size */
myresultsize=...
...
/* call parallel method (here the asynchronous function
my_par_func) */
my_par_job=poe_call_func_async(“my_par_func”,myargs,
myresultsize, number_of_processes, mypoeopts);
/* do other stuff specific to the application program*/
...
/* collect result form my_par_func */
if (poe_call_wait (my_par_job, &amp.myresult) ==0)
{ /* de-serialize myresult */
}

The structure of a typical parallel method —here a function—looks like

#include <mpi.h>
#include <string.h>
char* my_par_func(char** arguments)

/* declarations */
char* result;
...
/* de-serialize arguments */
...
/* do work (MPI calls are allowed - no MPI Init()

/MPI_Finalize () */

...
/* serialize result */
result=(char)malloc(size_of_serilaized_result);
strcpy(result,...); /* or similar string copying functions */
return result;

}

Next, for a UNIX enviroment the building and running of an application calling a parallel method will be described exemplarily:

The following example scenario shows how the application myapp that calls the parallel function my_par_func is built and started.

1. compile main program—here myapp calling my_par_func

$ c89-o myapp myapp.c

2. compile parallel subprogram assuming that the parallel method program source is in my_par_func.c

$ poe_call_build my_par_func . . .

3. distribute parallel subprogram

$ mcp poe_call_main_my_par_func

4. customize PATH variable such that both the application and the parallel subprogram can be loaded.

$ export PATH=<path to find myapp and

poe_call_main_my_par_func>:$PATH

5. start the application

$ myapp

Next, some implementation issues and alterntives are given referring to passing arguments of a parallel method to the parallel subprogram:

Alternative 1: pass arguments as command line agruments of the parallel subprogram when starting the parallel subprogram with poe.

Alternative 2: For large arguments of a parallel method it may be more appropriate to pass them to POE via interprocess communication as are e.g., pipes, named pipes, or shared memory segments and then let POE distribute the arguments to the parallel subprograms, e.g, by (mis)using standard input of the parallel subprogram.

In order to allow for a MPMD like programming model an array of functions must be expected as first argument of poe_call_func_* in order to support a MPMD like programming model. SPMD and MPMD like parallel method calls should use different Apis.

If a C++ API is supported then serialization and deserialisation work can be performed on objects with respective member methods.

The tool for instantiating the template of the parallel subprogram may have an option to delete the calls to MPI_Init and MPI_Finalize in case the parallel method does not all MPI functions.

In the foregoing specification the invention has been described with reference to a specific exemplary embodiment thereof. It will, however, be evident that various modifications and changes may be made thereto without departing from the broader spirit and scope of the invention as set forth in the appended claims. The specification and drawings are accordingly to be regarded as illustrative rather than in a restrictive sense.

The present invention can be realized in hardware, softwaref or a combination of hardware and software. A parallelization tool according to the present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after either or both of the following

a) conversion to another language, code or notation;

b) reproduction in a different material form.

1. Method for running in parallel at least one parallel method (28) associated with a sequential caller program means, the method comprising the step of:
issuing (220) a dedicated parallelization call to a parallel program managing means (18,22,26) comprising all control information needed to allow for running said parallel method (28) in parallel.

2. The method according to claim 1 further comprising the step of
serializing (210) input arguments for said subprogram means,
running (230, 240) said parallel method (28) in parallel on a different machine yielding a result,
returning (250, 260, 270) said result to the caller program,
deserializing (280) the result.

3. The method according to claim 1 further comprising the step of generating said parallel method (28) with a script program means which in turn is arranged to invoke a stream editor in order to fill a template means with the code or the name of the method (28) to be computed in parallel.

4. The method according to the preceding claim, further comprising the step of
automatically generating the instantiation of said template means.

5. The method according to the preceding claim in which a script is used for generating parallel subprograms.

6. The method according to claim 1 in which said dedicated parallelization call (220) is done more than once during the run of said caller program means.

7. The method according to the preceding claim in which the parallelization parameters are selectable for each dedicated parallelization call (220).

8. The method according claim 1 comprising the step of
using a program library which comprises program means for performing the steps according to the preceding claim 2 or 3.

9. A distributed computer system arranged for running in parallel at least one parallel method (28) associated with a sequential caller program means, said system comprising means for performing the steps according to one of the preceding claims.

10. Computer program comprising code portions adapted for performing the steps according to the method according to one of the preceding claims 1 to 6 when said program is loaded into a computer device.

11. Computer program product stored on a computer usable medium comprising computer readable program means for causing a computer to perform the method of any one of the claims 1 to 6.

12. Program library comprising at least one of:
an implementation of an application interface for procedural POE calls (220) to a parallel program managing means (22,26),
template means for parallel subprogram means,
script means for generating parallel subprograms.

13. The library according to the preceding claim which provides the prerequisites to generate user library functions that make parallelism transparent to a caller of said user library functions.

14. User library generated by means of the library according to claim 12.

15. The library according to claim 12 or claim 14 which is a dynamic link library.

16. A parallel program managing tool comprising program means for returning (250, 260, 270) results from parallel executable subprogram means.
